(19) United States
(12) Patent Application Publication
(10) Pub. No.: US 2013/0143094 A1
(43) Pub. Date: Jun. 6, 2013

(54) LITHIUM ION BATTERY

(71) Applicants: Jen-Chin Huang, New Taipei City (TW); Yu Zeng, Changshu City (CN)

(72) Inventors: Jen-Chin Huang, New Taipei City (TW); Yu Zeng, Changshu City (CN)

(73) Assignees: GOLDEN CROWN NEW ENERGY (HK) LIMITED, Kowloon (HK); SUZHOU GOLDEN CROWN NEW ENERGY CO., LTD., Changshu City (CN)

(21) Appl. No.: 13/361,592

(22) Filed: Jan. 30, 2012

(30) Foreign Application Priority Data
Dec. 2, 2011 (CN) 201110395171.5
Dec. 2, 2011 (CN) 201110395182.3

(51) Int. Cl. H01M 2/18; H01M 10/02

(52) U.S. Cl. 429/136; 429/153

(57) ABSTRACT

A lithium ion battery includes a casing, a cell assembly received in the casing, a cap assembly encapsulating the casing and electrolyte filling within the casing. The cell assembly comprises a number of stacked electrode plates and a separator sandwiched between two stacked electrode plates. The electrode plates comprise positive electrode plates and negative electrode plates. Each positive electrode plate is provided with a pair of negative electrode plates positioned on opposite sides of the positive electrode plate.

### CROSS-REFERENCE TO RELATED APPLICATION

This application claims priority to and the benefit of, pursuant to 35 U.S.C. §119(a), Chinese patent application Nos. 201110395182.3 and 201110395171.5, all filed Dec. 2, 2011. The disclosure of each of the above-identified Chinese patent applications is incorporated herein by reference in its entirety.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference were individually incorporated by reference.

### FIELD OF THE INVENTION

The present invention relates generally to a battery, and more particularly to a rechargeable lithium ion battery.

### BACKGROUND OF THE INVENTION

Generally, rechargeable batteries can be charged or discharged numerous times in comparison with conventional primary batteries which cannot be charged. Nowadays, lithium (Li) batteries, lithium ion batteries, and Ni-MH batteries are widely used as rechargeable battery. The rechargeable battery is usually classified into a liquid electrolyte battery and a polymer electrolyte battery based on the electrolyte used in the battery. Typically, the lithium ion battery is a liquid electrolyte battery. In the art, the lithium ion battery is manufactured in various shapes, such as cylindrical, rectangular, and pouch shapes.

Usually, the shape of the lithium ion battery has a great effect upon the design and manufacturing of the cell structure. For example, the cylindrical battery generally has a winded cell core structure, while, for a rectangular shape battery, a plurality of stacked electrode plates constitute a cell core structure. Currently, there are several methods to manufacture the stacked electrode plates or cell core structure for rectangular battery. For example, Chinese Patent No. 101485033 discloses a Zigzag method. Chinese Patent No. 101174681 discloses an insulator-bagging method. Chinese Patent No. 101405911 discloses an insulator-sectioning method.

For the Zigzag method, the positive pole and the negative pole are formed by plating positive/negative material on the plate and employing electrode ears connecting thereto, respectively. A separator will be positioned between neighbored two plates for insulation purposes. FIGS. 1 and 2 show a conventional cell assembly used in a lithium ion battery, in which the Zigzag method is applied. In the conventional cell assembly, as shown in FIG. 1, adjacent two faces 101 and 102 of the positive plates 103 do not correspondingly cooperate with none of the negative plates 104. Obviously, such region of the positive plates is waste and performance of the battery is decreased.

Therefore, a heretofore unaddressed need exists in the art to address the aforementioned deficiencies and inadequacies.

### SUMMARY OF THE INVENTION

In one aspect of the present invention, a lithium ion battery comprises a casing, a cell assembly received in the casing, a cap assembly encapsulating the casing and electrolyte filling within the casing. The cell assembly comprises a number of stacked electrode plates and a separator sandwiched between two stacked electrode plates. The electrode plates comprise positive electrode plates and negative electrode plates. Each positive electrode plate is provided with a pair of negative electrode plates positioned on opposite sides of the positive electrode plate.

In another aspect of the present invention, a lithium ion battery includes a cell assembly, a casing, a cap assembly and electrolyte. The cell assembly includes a plurality of stacked electrode plates and a separator sandwiched between two stacked electrode plates, and the plurality of electrode plates includes positive electrode plates and negative electrode plates. The casing contains the cell assembly. The cap assembly encapsulates the casing. The electrolyte is filled within the casing. Each positive electrode plate is provided with a pair of negative electrode plates positioned on opposite sides of the positive electrode plate.

In one embodiment, the separator is folded in a continuous Zigzag shape and defines a plurality of grooves therebetween, and the positive electrode plate and the negative electrode plate are formed alternatively in the grooves, respectively.

In one embodiment, the positive electrode plate is made of aluminum, opposite faces of which is covered with lithium ion.

In one embodiment, the negative electrode plate is made of copper or graphite, which is covered by the carbon related material. Further, the carbon related material covered on the negative electrode plate can be nanotubes. The two negative electrode plates which are oppositely positioned at outermost sides of the cell assembly can also be not covered by the carbon related material.

In one embodiment, the material of the separator is one of polyethylene (PE), polyprophlene (PP) or polyethylene terephthalate (PET).

In one embodiment, the cell assembly comprises a covering plate covering the stacked electrode plates and the separator. The material of the covering plate is the same as that of the separator. Further, the covering plate may extend from the separator.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a sketch view of a conventional cell assembly;

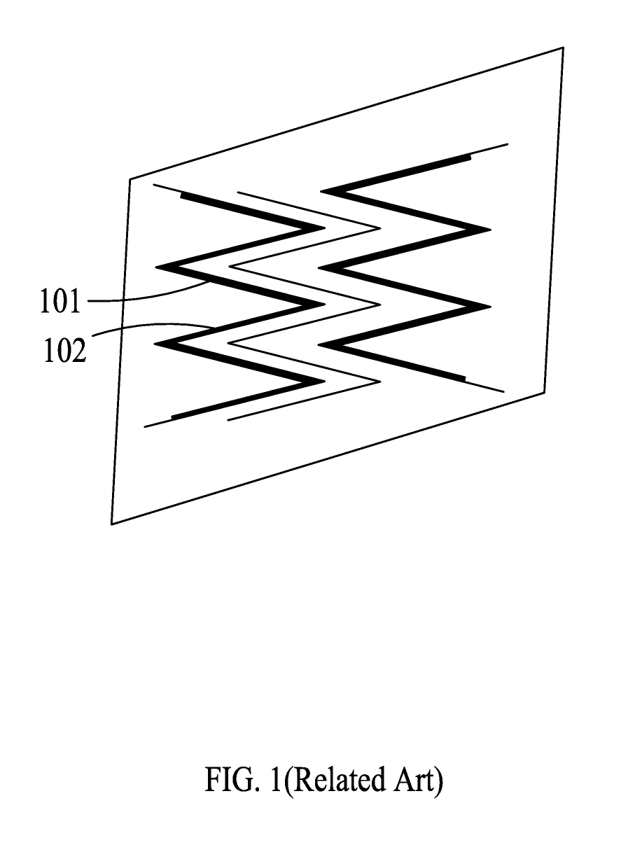

FIG. 2 is another sketch view of the conventional cell assembly shown in FIG. 1;

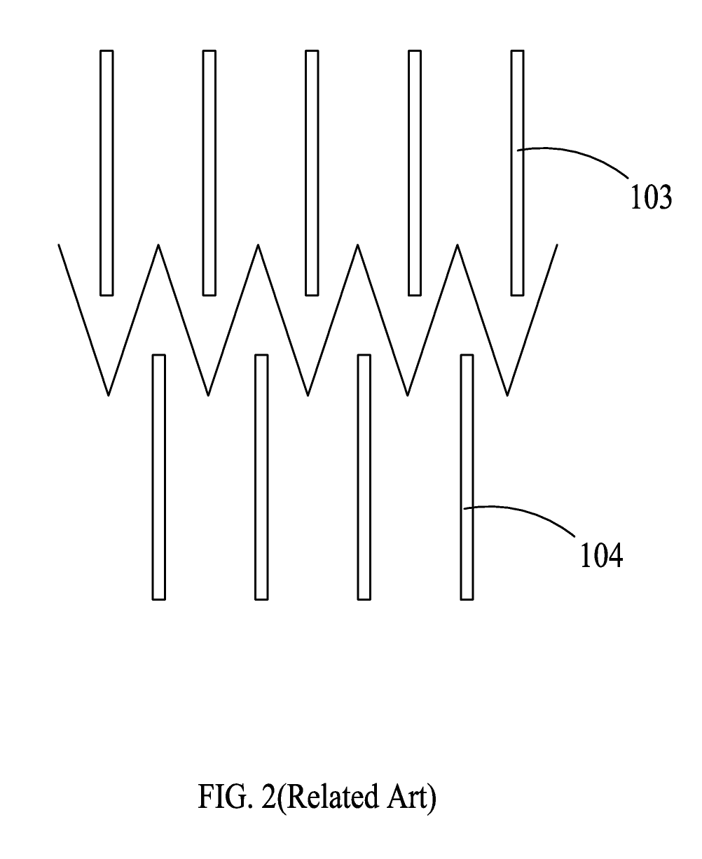

FIG. 3 is a sketched, perspective view of a lithium ion battery according to one embodiment of the present invention; and

FIG. 4 is a sketch view of a cell assembly of the lithium ion battery according to one embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

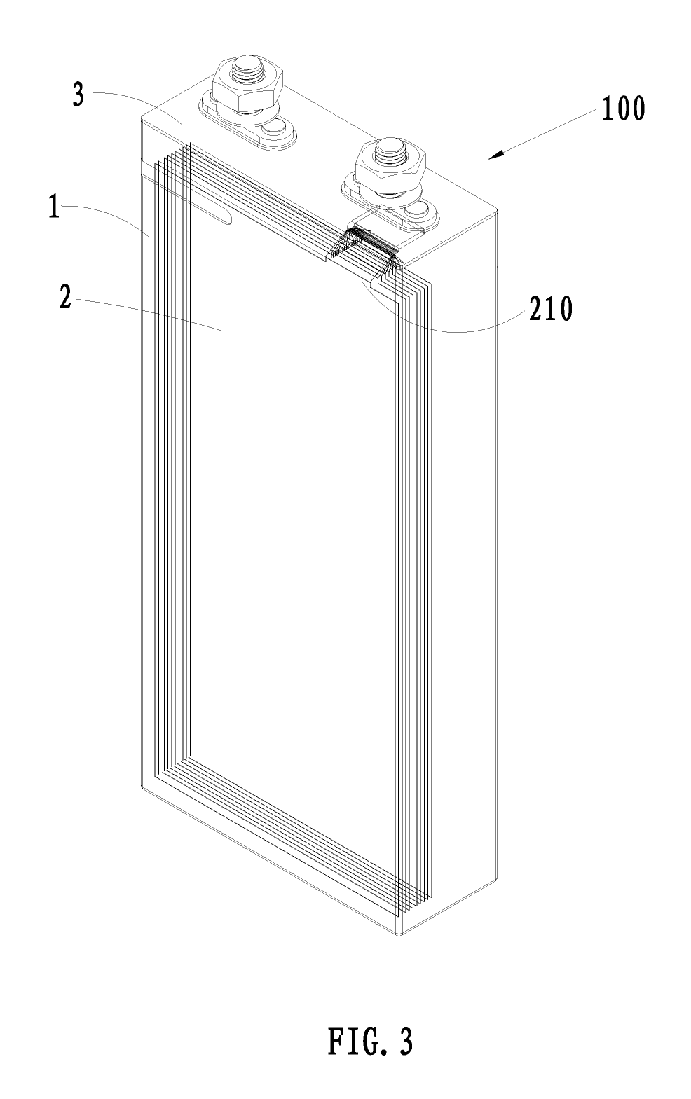

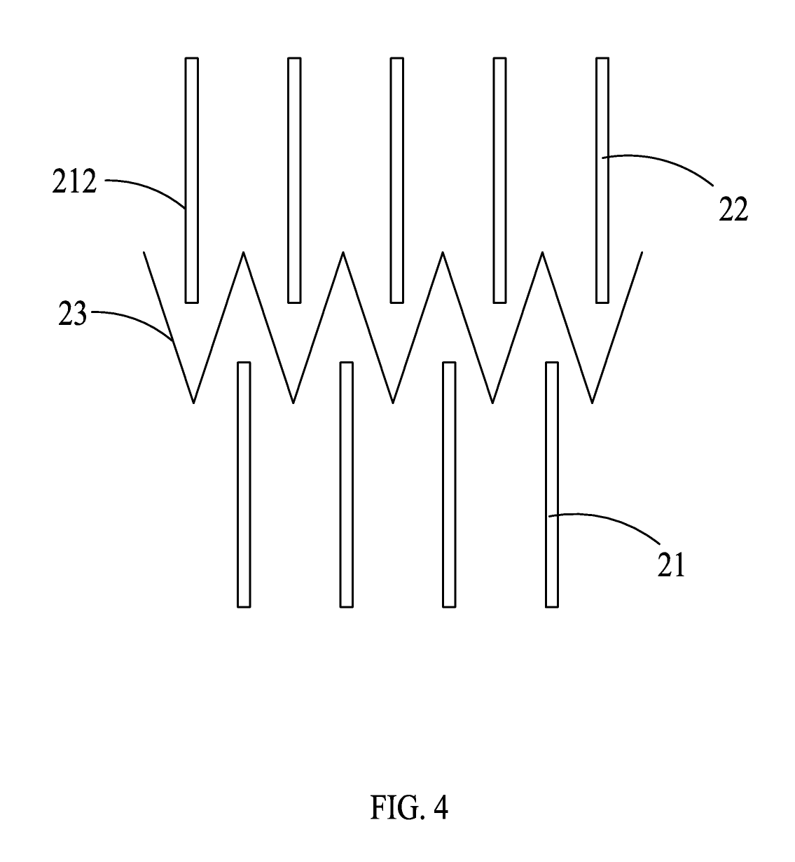

The description will be made as to the embodiments of the present invention in conjunction with the accompanying drawings in FIGS. 3 and 4. In accordance with the purposes of this invention, as embodied and broadly described herein, this invention, in one aspect, relates to a lithium ion battery.

Referring to FIGS. 3 and 4, a lithium ion battery 100 is shown according to one embodiment of the present invention, which is usable for a power source of an external device. The lithium ion battery 100 comprises a casing 1, a cell assembly 2 received in the casing 1, and a cap assembly 3 assembled to the casing 1. The electrolyte is filled within the casing 1. The cell assembly 2 includes stacked positive electrode plates 21, negative electrode plates 22 and a separator 23 positioned between the positive electrode plate 21 and the negative electrode plate 22. The positive electrode plate 21 has a rectangular shape, the material of which is preferred aluminum. As can be understood, other metal material can be also applied as for positive electrode plate. The positive electrode plate 21 has an electrode ear 210 connecting thereto which is employed for conducting electronic current occurred from the positive electrode plate 21. The electrode ear 210 is soldered on the positive electrode plate 21. Lithium ion material is plated on opposite faces of each positive electrode plate 21.

The negative electrode plate 22 has a rectangular shape, the material of which is preferred copper or graphite. Other conductive material is also applicable. Carbon related material, such as nanotubes, is plated on opposite faces of the negative electrode plate 22. Similarly, the negative electrode plate 22 has an electrode ear 220 connecting thereto. The electrode ear 220 is soldered onto the negative electrode plate 22. Since the lithium ions of the positive electrode plate 21 cannot flow directly to the outer faces of the two negative electrode plate 22 positioned on the outermost sides of the cell assembly 2, the outermost faces of the negative electrode plates 22 do not need to be plated a carbon related material as other part does. The lithium ions from each positive electrode plate 21 should be received by a carbon related material on the corresponding negative electrode plate 22. Therefore, the amount of the carbon related material plated on the negative electrode plates 22 is more than the amount of the lithium ions plated on the positive electrode plate 21 by about 10 percents, so as to ensure each of the negative electrode plates 22 can normally react with each of the positive electrode plates 21.

Referring to FIG. 4, the positive electrode plates 21 and the negative electrode plates 22 are alternatively arranged so that each positive electrode plate 21 is positioned between two negative electrode plates 22. That is, each positive electrode plate 21 has a pair of negative electrode plates 22 located on opposite sides thereof. The separator 23 is arranged between stacked positive electrode plate 21 and the negative electrode plate 22. The material for making the separator 23 is one of polyethylene (PE), polyprophlene (PP) or polyethylene terephthalate (PET). In the preferred embodiment, the separator 23 is folded as of a continuous Zigzag shape. A plurality of grooves are formed between the Zigzag shaped separator 23, which are for receiving the positive electrode plates 21 and the negative electrode plates 22.

The cell assembly 2 also has a covering plate (not shown) encapsulating the positive electrode plates 21, the negative electrode plates 22 and the separator 23. The covering plate has the same material as the separator. In the preferred embodiment, the covering plate can be formed by a distal end of the Zigzag type separator.

In sum, the present invention, among other things, recites a lithium ion battery, which includes a casing, a cell assembly received in the casing, a cap assembly encapsulating the casing and electrolyte filling within the casing. The cell assembly comprises a number of stacked electrode plates and a separator sandwiched between two stacked electrode plates. The electrode plates comprise positive electrode plates and negative electrode plates. Each positive electrode plate is provided with a pair of negative electrode plates positioned on opposite sides of the positive electrode plate.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. A lithium ion battery, comprising:
a cell assembly comprising a plurality of stacked electrode plates and a separator sandwiched between two stacked electrode plates, said plurality of electrode plates comprising positive electrode plates and negative electrode plates;
a casing containing said cell assembly;
a cap assembly encapsulating said casing; and
electrolyte filling within the casing,
wherein each positive electrode plate is provided with a pair of negative electrode plates positioned on opposite sides of said positive electrode plate.

2. The lithium ion battery as claimed in claim 1, wherein said separator is folded in a continuous Zigzag shape and defines a plurality of grooves therebetween, and wherein said positive electrode plate and said negative electrode plate are formed alternatively in said grooves, respectively.

3. The lithium ion battery as claimed in claim 1, wherein said positive electrode plate is made of aluminum, and opposite faces of which is covered with lithium ions.

4. The lithium ion battery as claimed in claim 1, wherein said negative electrode plate is made of copper or graphite, which is covered by a carbon related material.

5. The lithium ion battery as claimed in claim 4, wherein said carbon related material covered said negative electrode plate comprises nanotubes.

6. The lithium ion battery as claimed in claim 4, wherein the two negative electrode plates which are oppositely positioned at outermost sides of said cell assembly is not covered by said carbon related material.

7. The lithium ion battery as claimed in claim 1, wherein the material of said separator is one of polyethylene (PE), polyprophlene (PP), or polyethylene terephthalate (PET).

8. The lithium ion battery as claimed in claim 1, wherein said cell assembly comprises a covering plate covering said stacked electrode plates and said separator, wherein said covering plate is formed of the same material as that of said separator.

9. The lithium ion battery as claimed in claim 8, wherein said covering plate extends from said separator.
